(19) United States
(12) Patent Application Publication
(10) Pub. No.: US 2026/0147107 A1
(43) Pub. Date: May 28, 2026

(54) METHOD AND APPARATUS FOR AUGMENTING SYNTHESIS DATA OF THREE-DIMENSIONAL POINT CLOUD RADIO DETECTION AND RANGING-RECEIVED DATA

(71) Applicant: Electronics and Telecommunications Research Institute, Daejeon (KR)

(72) Inventors: You Jin KIM, Daejeon (KR); Kwang Hyo CHUNG, Daejeon (KR)

(73) Assignee: Electronics and Telecommunications Research Institute, Daejeon (KR)

(21) Appl. No.: 19/299,577

(22) Filed: Aug. 14, 2025

(30) Foreign Application Priority Data
Nov. 27, 2024 (KR) 10-2024-0172302
Mar. 14, 2025 (KR) 10-2025-0033506

(51) Int. Cl. G01S 13/58; G01S 13/89

(52) U.S. Cl. CPC G01S 13/582; G01S 13/89

(57) ABSTRACT

A method and apparatus for augmenting synthesis data of three-dimensional (3D) point cloud radio detection and ranging (radar)-received data are provided. The method includes generating correction data by performing Taylor first-order expansion correction on input data, generating synthesis noise data according to a data distribution of the input data, and outputting synthesis augmented data using the correction data and the synthesis noise data.

### CROSS-REFERENCE TO RELATED APPLICATION

This application claims the benefit of Korean Patent Application No. 10-2024-0172302, filed on Nov. 27, 2024, and Korean Patent Application No. 10-2025-0033506, filed on Mar. 14, 2025, in the Korean Intellectual Property Office, the entire disclosures of which are incorporated herein by reference for all purposes.

### BACKGROUND

### 1. Field of the Invention

One or more embodiments relate to a method and system for generating augmented data necessary for deep learning based on three-dimensional (3D) point cloud data and Doppler velocity data received from a frequency-modulated continuous-wave (FMCW) radio detection and ranging (radar).

### 2. Description of the Related Art

Frequency-modulated continuous-wave (FMCW) radio detection and ranging (radar) technology is technology of simultaneously measuring distance and velocity and is widely used in various applications such as monitoring activities of moving objects such as people, autonomous vehicles, drones, robots, and smart city management systems. Particularly, three-dimensional (3D) point cloud data and Doppler velocity data received from a radar play an essential role in precisely measuring and analyzing location and movement of objects.

However, the data received from an FMCW radar is likely to include noise and distortion due to environmental factors (e.g., the weather, characteristics of reflective surfaces, and radio wave interference) and systematic factors (e.g., signal processing limitation and sensor arrangement). This noise reduces reliability of distance and velocity calculation results, thereby degrading quality of deep learning training data and causing model performance degradation.

In addition, performance of a deep learning model is greatly dependent on diversity and quality of training data, but a process of collecting and refining FMCW radar data on a large scale requires a lot of cost and time. In addition, the radar data often lacks representation for particular environments (e.g., various weather conditions, complex surroundings, and presence of various objects that induce the Doppler effect), which may reduce generalization performance of the training data, and thus, the radar data may cause an issue of the model not adapting to various environments.

Therefore, a method of augmenting radar data for training data to be used in deep learning models while minimizing noise and distortion in the radar data is required.

### SUMMARY

Embodiments provide a method and system for minimizing noise and distortion of radio detection and ranging (radar) data and improving reliability of a radar system and data accuracy by applying Taylor first-order expansion to three-dimensional (3D) coordinate data and Doppler data received from a radar to correct distance and velocity data and then synthesizing and augmenting the distance and velocity data.

In addition, embodiments provide a method and system for solving an issue of insufficient training data, to be used in training a deep learning model, and improving diversity and practicality of the training data by generating synthesis augmented data similar to an actual environment by reflecting various noise conditions.

According to an aspect, there is provided a method of augmenting synthesis data, the method including generating correction data by performing Taylor first-order expansion correction on input data, generating synthesis noise data according to a data distribution of the input data, and outputting synthesis augmented data using the correction data and the synthesis noise data.

The method may further include separating the input data into 3D coordinate data and Doppler data, wherein the correction data may include corrected distance data and corrected velocity data, and the generating of the correction data may include generating the corrected distance data by performing Taylor first-order expansion correction on the 3D coordinate data and generating the corrected velocity data by performing Taylor first-order expansion correction on the Doppler data.

The generating of the corrected distance data may include generating synthesis distance data using the 3D coordinate data and generating the corrected distance data by performing Taylor first-order expansion correction on the synthesis distance data.

The generating of the synthesis distance data may include calculating a Euclidean distance with respect to the 3D coordinate data, calculating a weight-based distance with respect to the 3D coordinate data, calculating a probabilistic distance with respect to the 3D coordinate data, and outputting, as the synthesis distance data, one of a result of calculating the Euclidean distance, a result of calculating the weight-based distance, and a result of calculating the probabilistic distance.

The generating of the corrected velocity data may include generating synthesis velocity data using the Doppler data and generating the corrected velocity data by performing Taylor first-order expansion correction on the synthesis velocity data.

The generating of the synthesis velocity data may include calculating a basic Doppler velocity of the Doppler data, calculating a nonlinear Doppler correction velocity of the Doppler data, when the Doppler data includes multi-channel Doppler signals, calculating a multi-channel average velocity by combining the multi-channel Doppler signals, calculating a probabilistic estimation velocity of the Doppler data, and outputting, as the synthesis velocity data, one of a result of calculating the basic Doppler velocity, a result of calculating the nonlinear Doppler correction velocity, a result of calculating the multi-channel average velocity, and a result of calculating the probabilistic estimation velocity.

The generating of the synthesis noise data may include generating synthesis distance noise data, which is synthesis noise data with respect to distance, based on an average and variance of synthesis distance data generated using the 3D coordinate data and generating synthesis velocity noise data, which is synthesis noise data with respect to velocity, based on an average and variance of synthesis velocity data generated using the Doppler data.

The outputting of the synthesis augmented data may include generating augmented velocity data using the corrected distance data and the synthesis noise data, generating augmented 3D coordinate data by converting the augmented velocity data to 3D coordinates using the 3D coordinate data, generating augmented velocity data using the corrected velocity data and the synthesis noise data, and outputting synthesis augmented data including the augmented 3D coordinate data and the augmented velocity data.

According to another aspect, there is provided a synthesis data augmentation apparatus including a synthesis distance data generator configured to generate synthesis distance data using 3D coordinate data of input data, a first Taylor first-order expansion input corrector configured to generate corrected distance data by performing Taylor first-order expansion correction on the synthesis distance data, a synthesis velocity data generator configured to generate synthesis velocity data using Doppler data of the input data, a second Taylor first-order expansion input corrector configured to generate corrected velocity data by performing Taylor first-order expansion correction on the synthesis velocity data, a synthesis noise data generator configured to generate synthesis noise data according to data distribution of the synthesis distance data and the synthesis velocity data, and a third data merger configured to output synthesis augmented data generated using the corrected distance data, the corrected velocity data, and the synthesis noise data.

The synthesis data augmentation apparatus may further include a data divider configured to separate the input data into 3D coordinate data and Doppler data.

The synthesis distance data generator may include a Euclidean distance calculator configured to calculate a Euclidean distance with respect to the 3D coordinate data, a weight-based distance calculator configured to calculate a weight-based distance with respect to the 3D coordinate data, a probabilistic distance calculator configured to calculate a probabilistic distance with respect to the 3D coordinate data, and a selector configured to output, as the synthesis distance data, one of a result of calculating the Euclidean distance, a result of calculating the weight-based distance, and a result of calculating the probabilistic distance.

The synthesis velocity data generator may include a basic Doppler-based velocity calculator configured to calculate a basic Doppler velocity of the Doppler data, a nonlinear Doppler calculator configured to calculate a nonlinear Doppler correction velocity of the Doppler data, a multi-channel Doppler combiner configured to calculate a multi-channel average velocity by combining the multi-channel Doppler signals when the Doppler data includes multi-channel Doppler signals, a probabilistic velocity estimator configured to calculate a probabilistic estimation velocity of the Doppler data, and a selector configured to output, as the synthesis velocity data, one of a result of calculating the basic Doppler velocity, a result of calculating the nonlinear Doppler correction velocity, a result of calculating the multi-channel average velocity, and a result of calculating the probabilistic estimation velocity.

The synthesis noise data generator may be configured to generate synthesis distance noise data, which is synthesis noise data with respect to distance, based on an average and variance of synthesis distance data generated using the 3D coordinate data and generate synthesis velocity noise data, which is synthesis noise data with respect to velocity, based on an average and variance of synthesis velocity data generated using the Doppler data.

The synthesis data augmentation apparatus may further include a first data merger configured to generate augmented velocity data using the corrected distance data and the synthesis noise data, an augmented 3D coordinate converter configured to generate augmented 3D coordinate data by converting the augmented velocity data to 3D coordinates using the 3D coordinate data, and a second data merger configured to generate augmented velocity data using the corrected velocity data and the synthesis noise data, wherein the third data merger may be configured to output synthesis augmented data including the augmented 3D coordinate data and the augmented velocity data.

Additional aspects of embodiments will be set forth in part in the description which follows and, in part, will be apparent from the description, or may be learned by practice of the disclosure.

According to embodiments, noise and distortion of radar data may be minimized, and reliability of a radar system and data accuracy may be improved, by applying Taylor first-order expansion to 3D coordinate data and Doppler data received from a radar to correct distance and velocity data and then synthesizing and augmenting the distance and velocity data.

In addition, according to embodiments, by generating synthesis augmented data similar to an actual environment by reflecting various noise conditions, an issue of insufficient training data may be solved, and diversity and practicality of training data may be improved.

Furthermore, according to embodiments, a frame synchronization and merging block may provide a function of temporally and logically aligning input data and augmented data and merging and storing them in a consistent form, thereby facilitating data set management and ensuring consistency and reliability of data during a training and verification evaluation process of a deep learning model.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a radio detection and ranging (radar) system including a synthesis data augmentation apparatus, according to an embodiment;

FIG. 2 is a diagram illustrating a synthesis data augmentation apparatus according to an embodiment;

FIG. 3 is a detailed configuration of a synthesis distance data generator of a synthesis data augmentation apparatus, according to an embodiment;

FIG. 4 is a detailed configuration of a synthesis velocity data generator of a synthesis data augmentation apparatus, according to an embodiment;

FIG. 5 is a flowchart illustrating a synthesis data augmentation method according to an embodiment; and

FIG. 6 is a flowchart illustrating a corrected distance data generation process and a corrected velocity data generation process of a synthesis data augmentation method, according to an embodiment.

### DETAILED DESCRIPTION

Hereinafter, embodiments are described in detail with reference to the accompanying drawings. A synthesis data augmentation method according to an embodiment may be performed by a synthesis data augmentation apparatus.

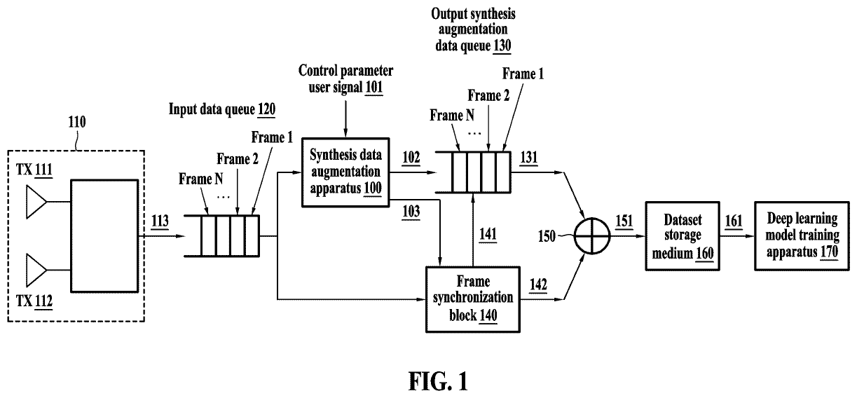

FIG. 1 is a diagram illustrating a radio detection and ranging (radar) system including a synthesis data augmentation apparatus, according to an embodiment.

As shown in FIG. 1, a radar system may include a frequency-modulated continuous-wave (FMCW) radar apparatus 110, an input data queue 120, a synthesis data augmentation apparatus 100, an output synthesis augmentation data queue 130, a frame synchronization block 140, a merge block 150, a dataset storage medium 160, and a deep learning model training apparatus 170.

The FMCW radar apparatus 110 may transmit FMCW radio waves from a transmission antenna (TX) 111. A reception antenna (RX) 112 of the FMCW radar apparatus 110 may receive the FMCW radio waves that are transmitted from the TX 111 and then reflected by an object. Here, a processor of the FMCW radar apparatus 110 may process a received signal and may output original raw data 113 including three-dimensional (3D) point cloud data and

Doppler velocity data.

For example, the original raw data 113 may include the following fields:

Frame #: Frame number in which data is collected. #Obj: Total number of objects detected in a frame.

X, Y, Z: 3D coordinates of an object.

Doppler: Doppler value representing relative velocity of the object.

Intensity: Signal intensity (strength) of the object.

Abs Time: Absolute time value (timestamp).

The input data queue 120 may be stored in a volatile storage medium or a non-volatile storage medium. The original raw data 113 output from the FMCW radar apparatus 110 may be sequentially input to the input data queue 120 for each frame number. In addition, output of the input data queue 120 may be input to the synthesis data augmentation apparatus 100 and the frame synchronization block 140.

The synthesis data augmentation apparatus 100 may perform Taylor first-order expansion correction on the output of the input data to generate correction data. Next, the synthesis data augmentation apparatus 100 may generate synthesis noise data according to data distribution of the input data. Subsequently, the synthesis data augmentation apparatus 100 may output synthesis augmentation data using the correction data and the synthesis noise data. Here, the input data of the synthesis data augmentation apparatus 100 may be the output of the input data queue 120.

The frame synchronization block 140 may output the data input from the input data queue 120 to the merge block 150. Here, data 142 output by the frame synchronization block 140 and the data input from the input data queue 120 may be the same data. In addition, the frame synchronization block 140 may perform a function to match frame synchronization between a synthesis augmented data 102 output from the synthesis data augmentation apparatus 100 and the data 142 output to the merge block 150.

Specifically, the frame synchronization block 140 may perform synchronization based on a timestamp and a frame number by comparing the data output from the input data queue 120 to the synthesis augmented data 102 generated from the synthesis data augmentation apparatus 100. In addition, the frame synchronization block 140 may generate a control signal 103 according to a result of performing the synchronization.

Here, the frame synchronization block 140 may perform control 141 so that the output of an output synthesis augmentation data queue 130 is output for each frame order according to control of the control signal 103 output from the synthesis data augmentation apparatus 100. The output synthesis augmentation data queue 130 may be stored in a volatile storage medium or a non-volatile storage medium. The output synthesis augmentation data queue 130 may sequentially output the synthesis augmented data 102 output from the synthesis data augmentation apparatus 100 under control of the frame synchronization block 140.

That is, the frame synchronization block 140 may synchronize the data 142 and data 131 output from the output synthesis augmentation data queue 130 as output for each frame, such as {Frame 1, Frame 1′}, {Frame 2, Frame 2′}, . . . {Frame N, Frame N′}. For example, Frame N′ may be synthesis augmented data based on physical information 102 output from the synthesis data augmentation apparatus 100.

The merge block 150 may perform merging of the data 131 and the data 142 based on a synchronized data pair. Here, the merging may be performed based on a frame number, and merged data 151 may be stored in the dataset storage medium 160. In addition, the merge block 150 may maintain data consistency during the merging process and may add additional metadata (e.g., an augmentation type and a physical correction value) if necessary. For example, the merged data 151 in which the data 142 for a frame number 925, a frame 925, and the data 131 for a frame number 925′, a frame 925′, are merged may have a configuration as shown in Table 1.

TABLE 1
{Frame 925, Frame 925′}
Frame 925

| Frame # | X | Y | Z | Doppler(v) | X′ | Y′ | Z′ | Doppler(v)′ |
|---|---|---|---|---|---|---|---|---|
| 925 | 0.35742 | 1.8652 | 0.12695 | 0.356 | 0.12695 | 1.8662 | 0.35742 | 0.71201 |
| 925 | 0.54395 | 1.8359 | 0.26758 | 0.356 | 1.8662 | 1.8359 | 0.26758 | 0.356 |
| 925 | 0.49023 | 1.8662 | 0.35742 | 0.71201 | 0.35742 | 1.8652 | 0.35742 | 0.26758 |

The data stored in the dataset storage medium 160 may be configured as an augmented data set for training 161 and transmitted to the deep learning model training apparatus 170. The deep learning model training apparatus 170 may improve generalization performance of a deep learning model by performing training of the deep learning model using the augmented data set for training 161.

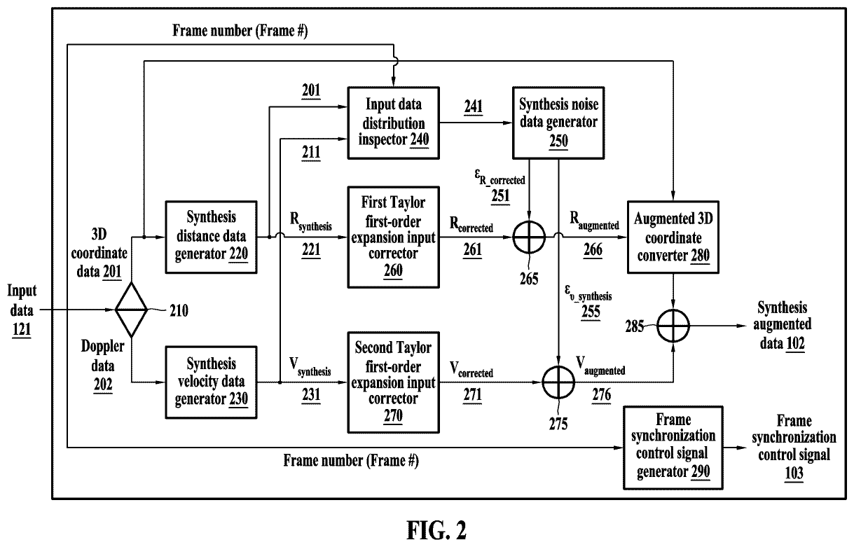

A control parameter user signal 101 may be a control signal input to the synthesis data augmentation apparatus 100 and may be a signal that inputs all parameters required for controlling detailed configurations of the synthesis data augmentation apparatus 100. Since the control parameter user signal 101 is input to all the detailed configurations of the synthesis data augmentation apparatus 100, operations of the detailed configurations of the synthesis data augmentation apparatus 100, shown in FIG. 2, may be performed according to the control parameter user signal 101.

FIG. 2 is a diagram illustrating a synthesis data augmentation apparatus according to an embodiment.

The synthesis data augmentation apparatus 100 may include a data divider 210, a synthesis distance data generator 220, a synthesis velocity data generator 230, an input data distribution inspector 240, a synthesis noise data generator 250, a first Taylor first-order expansion input corrector 260, a first data merger 265, a second Taylor first-order expansion input corrector 270, a second data merger 275, an augmented 3D coordinate converter 280, a third data merger 285, and a frame synchronization control signal generator 290, as shown in FIG. 2. Here, the data divider 210, the synthesis distance data generator 220, the synthesis velocity data generator 230, the input data distribution inspector 240, the synthesis noise data generator 250, the first Taylor first-order expansion input corrector 260, the first data merger 265, the second Taylor first-order expansion input corrector 270, the second data merger 275, the augmented 3D coordinate converter 280, the third data merger 285, and the frame synchronization control signal generator 290 may be different processors, as shown in FIG. 2, or may each be modules included in a program executed in one processor.

The data divider 210 may separate 3D point cloud data from input data 121 into 3D coordinate data (X, Y, Z) 201 and may output the 3D coordinate data 201. In addition, the data divider 210 may separate Doppler velocity data from the input data 121 into Doppler data (Doppler velocity: v) 202 and may output the Doppler data 202. Here, the 3D coordinate data 201 may be transmitted to the synthesis distance data generator 220 and the augmented 3D coordinate converter 280, and the Doppler data 202 may be transmitted to the synthesis velocity data generator 230.

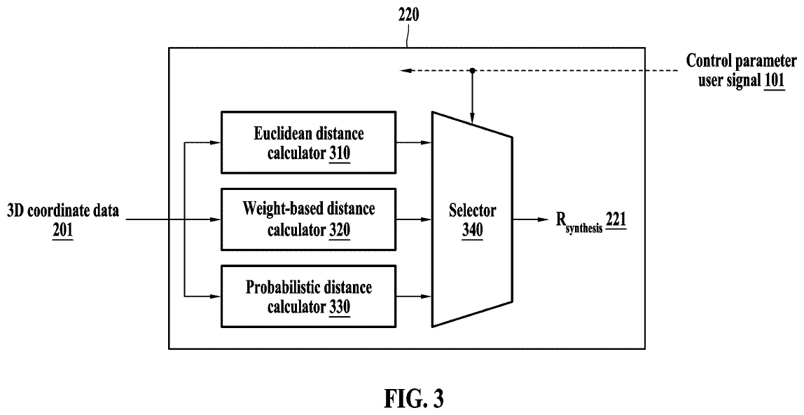

The synthesis distance data generator 220 may output synthesis distance data R_{synthesis} 221 using the 3D coordinate data 201. A detailed configuration of the synthesis distance data generator 220 is described in detail with reference to FIG. 3 below.

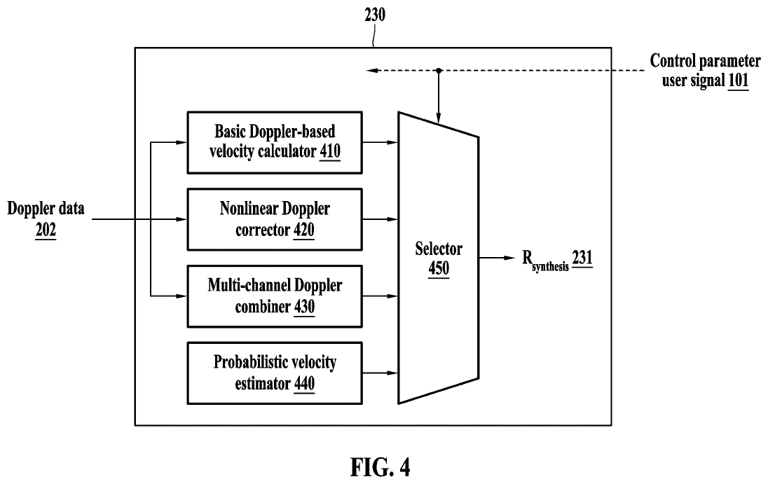

The synthesis velocity data generator 230 may output synthesis velocity data v_{synthesis} 231 using the Doppler data 202. A detailed configuration of the synthesis velocity data generator 230 is described in detail with reference to FIG. 4 below.

The input data distribution inspector 240 may receive the synthesis distance data R_{synthesis} 221 and the synthesis velocity data v_{synthesis} 231. In addition, the input data distribution inspector 240 may receive a frame number (frame #) of the input data 121 and may inspect data distribution of the synthesis distance data R_{synthesis} 221 and the synthesis velocity data v_{synthesis} 231 within the same frame number. Here, the input data distribution inspector 240 may inspect the data distribution of the synthesis distance data R_{synthesis} 221 and the synthesis velocity data v_{synthesis} 231 to determine an average value and variance of the distance data and an average value and variance of the velocity data, thereby identifying the center and variability of the input data and increasing accuracy when augmenting the data.

For example, the input data distribution inspector 240 may determine an average value μ_{R}_{_{synthesis}} of the synthesis distance data R_{synthesis} 221 using Equation 1.

$$μ {R}_{synthesis} = \frac{1}{n} {\sum }_{i = 1}^{n} {R}_{synthesis , i} \qquad [ Equation 1 ]$$

The average value μ_{R}_{_{synthesis}} of the synthesis distance data R_{synthesis} 221 may represent a center value of “n” distance data samples included in the input data.

In addition, the input data distribution inspector 240 may determine a variance value

$${σ}_{{R}_{synthesis}}^{2}$$

of the synthesis distance data R_{synthesis} 221 using Equation 2.

$${σ}_{{R}_{synthesis}}^{2} = \frac{1}{n} {\sum }_{i = 1}^{n} {( {R}_{synthesis , i} - μ {R}_{synthesis} )}^{2} \qquad [ Equation 2 ]$$

The variance value

$${σ}_{{R}_{synthesis}}^{2}$$

of the synthesis distance data R_{synthesis} 221 may The variance value represent the variability of the distance data samples included in the input data.

In addition, the input data distribution inspector 240 may determine an average value μᵥ_{_{synthesis}} of the synthesis velocity data v_{synthesis} 231 using Equation 3.

$${μ}_{{υ}_{synthesis}} = \frac{1}{n} {\sum }_{i = 1}^{n} {υ}_{synthesis , i} \qquad [ Equation 3 ]$$

The average value μᵥ_{_{synthesis}} of the of the synthesis velocity data v_{synthesis} 231 may represent a center value of “n” velocity data samples included in the input data.

In addition, the input data distribution inspector 240 may determine a variance value

$${σ}_{{R}_{synthesis}}^{2}$$

of the synthesis velocity data v_{synthesis} 231 using Equation 4.

$${σ}_{{R}_{synthesis}}^{2} = \frac{1}{n} {\sum }_{i = 1}^{n} {( {υ}_{synthesis , i} - {μ}_{{υ}_{synthesis}} )}^{2} \qquad [ Equation 4 ]$$

The variance value

$${σ}_{{υ}_{synthesis}}^{2}$$

of the synthesis velocity data v_{synthesis} 231 may represent the variability of the velocity data samples included in the input data.

In addition, a data distribution inspection result 241 of the input data distribution inspector 240 may be transmitted to the synthesis noise data generator 250. That is, the data distribution inspection result 241 may include the average and variance of the synthesis distance data R_{synthesis} 221 and the average and variance of the synthesis velocity data v_{synthesis} 231.

The synthesis noise data generator 250 may generate synthesis distance noise data ϵ_{R}_{_{synthesis}} 251, which is synthesis noise data for distance, based on the average and variance of the synthesis distance data R_{synthesis} 221 included in the data distribution inspection result 241. For example, the synthesis noise data generator 250 may generate the synthesis distance noise data ϵ_{R}_{_{synthesis}} 251 using Equation 5.

$${ϵ}_{{R}_{synthesis}} = α \cdot 𝒩 ( 0 , {σ}_{{R}_{synthesis}}^{2} ) + β \cdot U ( {a}_{{R}_{synthesis}} , {b}_{{R}_{synthesis}} ) \qquad [ Equation 5 ]$$

Here,

$$𝒩 ( 0 , {σ}_{{R}_{synthesis}}^{2} )$$

may be Gaussian noise having an average of 0 and a variance of

$${σ}_{{R}_{synthesis}}^{2}$$

and may be determined based on the variability of the synthesis distance data R_{synthesis} 221. In addition, U(a_{R}_{_{synthesis}},b_{R}_{_{synthesis}}) may be noise generated with a uniform distribution in a range [a_{R}_{_{synthesis}},b_{R}_{_{synthesis}}]. In addition, α may be a weight that adjusts contribution of the Gaussian noise, and β may be a weight that adjusts contribution of uniform noise.

Furthermore, the synthesis noise data generator 250 may generate synthesis velocity noise data ϵᵥ_{_{synthesis}} 255, which is synthesis noise data for velocity, based on the average and variance of the synthesis velocity data v_{synthesis} 231 included in the data distribution inspection result 241. For example, the synthesis noise data generator 250 may generate the synthesis velocity noise data ϵᵥ_{_{synthesis}} 255 using Equation 6.

$${ϵ}_{{υ}_{synthesis}} = γ \cdot 𝒩 ( 0 , {σ}_{{υ}_{synthesis}}^{2} ) + δ \cdot U ( {a}_{{υ}_{synthesis}} , {b}_{{υ}_{synthesis}} ) \qquad [ Equation 6 ]$$

Here,

$$𝒩 ( 0 , {σ}_{{υ}_{synthesis}}^{2} )$$

may be Gaussian noise having an average of 0 and a variance of

$${σ}_{{υ}_{synthesis}}^{2}$$

and may be determined based on the variability of the synthesis velocity data v_{synthesis} 231. In addition, U(aᵥ_{_{synthesis}},bᵥ_{_{synthesis}}) may be noise generated with a uniform distribution in a range [aᵥ_{_{synthesis}},bᵥ_{_{synthesis}}]. In addition, γ may be a weight that adjusts contribution of the Gaussian noise, and δ may be a weight that adjusts contribution of uniform noise.

The first Taylor first-order expansion input corrector 260 may perform Taylor first-order expansion input correction on the synthesis distance data R_{synthesis} 221 to output corrected distance data R_{corrected} 261. For example, the first Taylor first-order expansion input corrector 260 may determine the corrected distance data R_{corrected} 261 by applying correction for input signal distortion (frequency error ϵ_{b}) to the synthesis distance data R_{synthesis} 221, as shown in Equation 7.

$${R}_{corrected} = {R}_{synthesis} + \frac{\partial R}{\partial {f}_{b}} \cdot {ϵ}_{b} \qquad [ Equation 7 ]$$

Here, ϵ_{b} may be a frequency error or a noise component depending on a system environment. In addition,

$$\frac{\partial R}{\partial {f}_{b}}$$

may be a partial derivative of a distance with respect to f_{b} and may represent influence of ϵ_{b} on the distance data. In addition,

$$\frac{\partial R}{\partial {f}_{b}}$$

may be defined as Equation 8.

$$\frac{\partial R}{\partial {f}_{b}} = \frac{c}{2 S} \qquad [ Equation 8 ]$$

Here, c may be the velocity of light (3×10⁸ m/s), and S may be the frequency change rate (Hz/s) of the transmitted signal.

The first data merger 265 may merge the corrected distance data R_{corrected} 261 and the synthesis distance noise data ϵ_{R}_{_{synthesis}} 251 to output augmented distance data R_{augmented} 266. For example, the first data merger 265 may determine the augmented distance data R_{augmented} 266 according to Equation 9.

$${R}_{augmented} = {R}_{corrected} + {ϵ}_{{R}_{synthesis}} \qquad [ Equation 9 ]$$

The second Taylor first-order expansion input corrector 270 may perform Taylor first-order expansion input correction on the synthesis velocity data v_{synthesis} 231 to output corrected velocity data v_{corrected} 271. For example, the second Taylor first-order expansion input corrector 270 may determine the corrected velocity data v_{corrected} 271 by applying correction for input signal distortion (Doppler frequency error ϵ_{d}) to the synthesis velocity data v_{synthesis} 231, as shown in Equation 10.

$${υ}_{corrected} = {υ}_{synthesis} + \frac{\partial υ}{\partial {f}_{d}} \cdot {ϵ}_{d} \qquad [ Equation 10 ]$$

Here, ϵ_{d} may be a Doppler frequency error or a noise component that may occur in radar signal processing. In addition,

$$\frac{\partial υ}{\partial {f}_{d}}$$

may be a partial derivative of velocity with respect to f_{d} and may represent influence of ϵ_{b} on the velocity data. In addition,

$$\frac{\partial υ}{\partial {f}_{d}}$$

may be defined as in Equation 11.

$$\frac{\partial υ}{\partial {f}_{d}} = \frac{λ}{2} \qquad [ Equation 11 ]$$

Here, λ may be a wavelength

$$λ = \frac{c}{{f}_{c}} ,$$

of a radar signal. In addition, f_{c} may be the center frequency of a transmission signal.

The second data merger 275 may merge the corrected velocity data v_{corrected} 271 and the synthesis velocity noise data ϵᵥ_{_{synthesis}} 255 to output augmented velocity data v_{augmented} 276. For example, the second data merger 275 may determine the augmented velocity data v_{augmented} 276 according to Equation 12.

$${υ}_{augmented} = {υ}_{corrected} + {ϵ}_{{υ}_{synthesis}} \qquad [ Equation 12 ]$$

The augmented 3D coordinate converter 280 may receive the augmented distance data R_{augmented} 266 and the 3D coordinate data 201. Here, the augmented 3D coordinate converter 280 may output augmented 3D coordinate data (X′, Y′, Z′) by converting the augmented distance data R_{augmented} 266 to 3D coordinates using the 3D coordinate data 201 as a reference coordinate.

For example, the augmented 3D coordinate converter 280 may determine an original distance R from the 3D coordinate data 201 according to Equation 13.

$$R = \sqrt{{X}^{2} + {Y}^{2} + {Z}^{2}} \qquad [ Equation 13 ]$$

Next, the augmented 3D coordinate converter 280 may determine the augmented 3D coordinate data (X′, Y′, Z′) by applying the original distance R and the augmented distance data R_{augmented} 266 to Equation 14.

$${X}^{′} = \frac{{R}_{augmented}}{R} \cdot X , {Y}^{′} = \frac{{R}_{augmented}}{R} \cdot {Y}_{,} {Z}^{′} = \frac{{R}_{augmented}}{R} \cdot Z \qquad [ Equation 14 ]$$

The third data merger 285 may merge the augmented 3D coordinate data (X′, Y′, Z′) with the augmented velocity data v_{augmented} 276 to output the synthesis augmented data 102. That is, the synthesis augmented data 102 may include the augmented 3D coordinate data and the augmented velocity data. For example, the synthesis augmented data 102 may be X′, Y′, Z′, v′.

The frame synchronization control signal generator 290 may generate a frame synchronization control signal to individually perform 3D point cloud data within the same frame number based on the frame number (frame #) of the input data 121.

FIG. 3 is a detailed configuration of a synthesis distance data generator of a synthesis data augmentation apparatus, according to an embodiment.

The synthesis distance data generator 220 may include a Euclidean distance calculator 310, a weight-based distance calculator 320, a probabilistic distance calculator 330, and a selector 340, as shown in FIG. 3.

The Euclidean distance calculator 310 may calculate a Euclidean distance with respect to the 3D coordinate data 201. For example, the Euclidean distance calculator 310 may calculate the Euclidean distance that may be selected as the synthesis distance data R_{synthesis} 221 by the selector 340 using Equation 15.

$${R}_{synthesis} = \sqrt{{X}^{2} + {Y}^{2} + {Z}^{2}} \qquad [ Equation 15 ]$$

The weight-based distance calculator 320 may calculate a weight-based distance with respect to the 3D coordinate data 201. For example, the weight-based distance calculator 320 may calculate the weight-based distance that may be selected as the synthesis distance data R_{synthesis} 221 by the selector 340 using Equation 16.

$${R}_{synthesis} = \sqrt{{w}_{X} {X}^{2} + {ω}_{Y} {Y}^{2} + {w}_{Z} {Z}^{2}} \qquad [ Equation 16 ]$$

Here, w_{X}, w_{Y}, w_{Z} may be a weight for each axis.

The probabilistic distance calculator 330 may calculate a probabilistic distance with respect to the 3D coordinate data 201. For example, the probabilistic distance calculator 330 may calculate the probabilistic distance that may be selected as the synthesis distance data R_{synthesis} 221 by the selector 340 using Equation 17.

$${R}_{synthesis} \sim 𝒩 ( {μ}_{R} , {σ}_{R}^{2} ) \qquad [ Equation 17 ]$$

Here, μ_{R} may be an average value of the distance data included in the 3D coordinate data 201,

$${σ}_{R}^{2}$$

and may be a variance value of the distance data included in the 3D coordinate data 201.

The selector 340 may output, as synthesis distance data, a result that is selected from among a result of calculating the Euclidean distance by the Euclidean distance calculator 310, a result of calculating the weight-based distance by the weight-based distance calculator 320, and a result of calculating the probabilistic distance by the probabilistic distance calculator 330, according to a control parameter user signal 101.

The Euclidean distance may be suitable for standard distance calculation since the Euclidean distance is simple and fast to calculate. In addition, the weight-based distance may reflect importance of a specific axis (e.g., a vertical distance in the case of a Z-axis), thereby having an advantage of utilization in an asymmetric environment of surrounding environments (e.g., road and obstacle detection). Furthermore, the probabilistic distance may have an advantage of reflecting uncertainty of an environment through a probabilistic approach and may be utilized for reliable distance calculation in abnormal environments (e.g., bad weather, etc.).

Therefore, the control parameter user signal 101 may be a signal for selecting one of the Euclidean distance, the weight-based distance, and the probabilistic distance according to the advantages of the Euclidean distance, the weight-based distance, and the probabilistic distance and characteristics of information required by a deep learning model training apparatus.

FIG. 4 is a detailed configuration of a synthesis velocity data generator of a synthesis data augmentation apparatus, according to an embodiment.

As shown in FIG. 4, the synthesis velocity data generator 230 may include a basic Doppler-based velocity calculator 410, a nonlinear Doppler corrector 420, a multi-channel Doppler combiner 430, a probabilistic velocity estimator 440, and a selector 450.

The basic Doppler-based velocity calculator 410 may calculate a basic Doppler velocity of the Doppler data 202. For example, the basic Doppler-based velocity calculator 410 may calculate the basic Doppler velocity that may be selected as the synthesis velocity data v_{synthesis} 231 by the selector 450 using Equation 18.

$${υ}_{synthesis} = \frac{λ \cdot {f}_{d}}{2} \qquad [ Equation 18 ]$$

Here, f_{d} may be a Doppler frequency deviation (hertz (Hz)).

The nonlinear Doppler corrector 420 may calculate a nonlinear Doppler correction velocity of the Doppler data 202. For example, the nonlinear Doppler corrector 420 may calculate the nonlinear Doppler correction velocity that may be selected as the synthesis velocity data v_{synthesis} 231 by the selector 450 using Equation 19.

$${υ}_{synthesis} = \frac{λ \cdot {f}_{d}}{2} + {k}_{1} {f}_{d}^{2} + {k}_{2} {f}_{d}^{3} + \qquad [ Equation 19 ]$$

k₁, k₂ Here, may be nonlinear correction coefficients.

When the Doppler data 202 includes multi-channel Doppler signals, the multi-channel Doppler combiner 430 may calculate a multi-channel average velocity by combining the multi-channel Doppler signals. For example, the multi-channel Doppler combiner 430 may calculate the multi-channel average velocity that may be selected as the synthesis velocity data v_{synthesis} 231 by the selector 450 using Equation 20.

$${υ}_{synthesis} = \frac{1}{N} {\sum }_{i = 1}^{N} \frac{λ \cdot {f}_{d , i}}{2} \qquad [ Equation 20 ]$$

Here, N may be the number of reception channels, and f_{d,i} may be a Doppler frequency (Hz) of an i-th channel.

The probabilistic velocity estimator 440 may calculate a probabilistic estimation velocity of the Doppler data 202. For example, the basic Doppler-based velocity calculator 410 may calculate the basic Doppler velocity that may be selected as the synthesis velocity data v_{synthesis} 231 by the selector 450 using Equation 21.

$${υ}_{synthesis} \sim 𝒩 ( {μ}_{R} , {σ}_{υ}^{2} ) \qquad [ Equation 21 ]$$

Here, μᵥ may be an average value of the velocity data included in the Doppler data 202,

$${σ}_{υ}^{2}$$

may be a variance value of the velocity data included in the Doppler data 202, and

$$𝒩 ( {μ}_{R} , {σ}_{R}^{2} )$$

may be a normal distribution of the velocity data included in the Doppler data 202.

The selector 450 may output, as the synthesis velocity data v_{synthesis} 231, one of a result of calculating the basic Doppler velocity by the basic Doppler-based velocity calculator 410, a result of calculating the nonlinear Doppler correction velocity by the nonlinear Doppler corrector 420, a result of calculating the multi-channel average velocity by the multi-channel Doppler combiner 430, and a result of calculating the probabilistic estimation velocity by the probabilistic velocity estimator 440.

Since the basic Doppler velocity is based on physical principles, the basic Doppler velocity may be intuitive for reflecting physical data and may allow standardized velocity calculation. In addition, the nonlinear Doppler correction velocity may reflect environmental factors (e.g., asymmetry of a reflective surface and nonlinear response of a radar apparatus) and may better reflect physical characteristics of complex Doppler signals than a simple linear model, and thus, the nonlinear Doppler correction velocity may be effectively used even for high-velocity moving objects that require improved accuracy in velocity estimation or in situations with severe environmental noise. Furthermore, the multi-channel Doppler combining method performed by the multi-channel Doppler combiner 430 may include correcting errors (e.g., noise and interference) of a single signal by receiving Doppler signals from multiple channels and averaging the Doppler signals, and thus, random noise may be offset through averaging of multiple observation values, thereby obtaining reliable velocity values. In addition, the probabilistic velocity may reflect uncertainty of estimated values by expressing the velocity as a probability distribution rather than a single value and may augment training data of various scenarios by sampling from a probabilistic velocity distribution.

Therefore, the control parameter user signal 101 may be a signal for selecting one of the basic Doppler velocity, the nonlinear Doppler correction velocity, the multi-channel average velocity, and the probabilistic velocity according to advantages of the basic Doppler velocity, the nonlinear Doppler correction velocity, the multi-channel Doppler combining method, and the probabilistic velocity and the characteristics of information required by a deep learning model training apparatus.

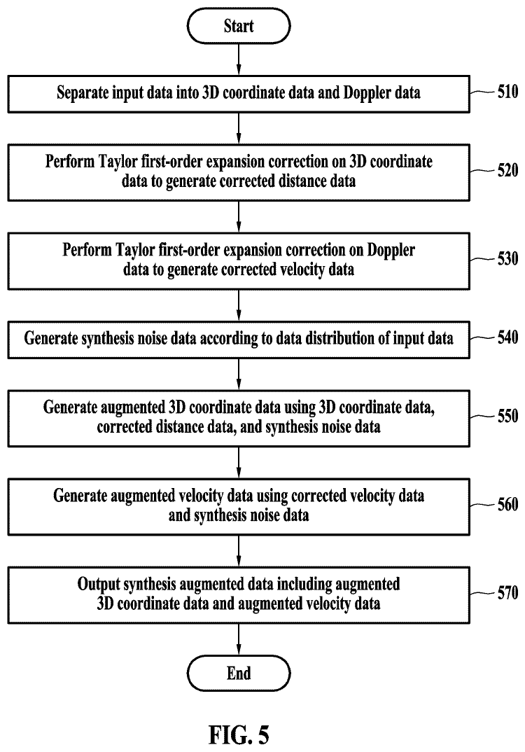

FIG. 5 is a flowchart illustrating a synthesis data augmentation method according to an embodiment.

In operation 510, the data divider 210 may separate input data into 3D coordinate data and Doppler data and may output them.

In operation 520, the synthesis distance data generator 220 and the first Taylor first-order expansion input corrector 260 may perform Taylor first-order expansion correction on the 3D coordinate data of the input data to generate corrected distance data.

In operation 530, the synthesis velocity data generator 230 and the second Taylor first-order expansion input corrector 270 may perform Taylor first-order expansion correction on the Doppler data of the input data to generate corrected velocity data.

In operation 540, the synthesis noise data generator 250 may generate synthesis noise data according to data distribution of the input data. The synthesis noise data generated by the synthesis noise data generator 250 may include synthesis distance noise data ϵ_{R}_{_{synthesis}}, which is synthesis noise data with respect to distance, and synthesis velocity noise data ϵᵥ_{_{synthesis}}, which is synthesis noise data with respect to velocity.

In operation 550, the first data merger 265 may merge corrected distance data R_{corrected} with the synthesis distance noise data ϵ_{R}_{_{synthesis}} to output augmented distance data R_{augmented}. In addition, the augmented 3D coordinate converter 280 may generate the augmented 3D coordinate data (X′, Y′, Z′) by converting the augmented distance data R_{augmented} into 3D coordinates using the 3D coordinate data separated in operation 510 as reference coordinates.

In operation 560, the second data merger 275 may merge corrected velocity data v_{corrected} with the synthesis velocity noise data ϵᵥ_{_{synthesis}} to generate augmented velocity data v_{augmented}.

In operation 570, the third data merger 285 may merge the augmented 3D coordinate data (X′, Y′, Z′) generated in operation 550 with the augmented velocity data v_{augmented} generated in operation 560 to output synthesis augmented data.

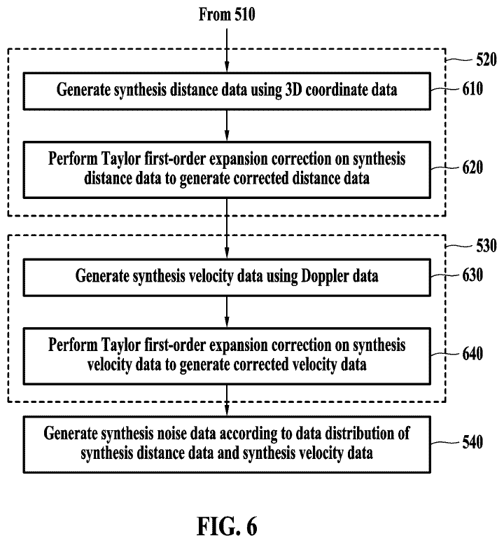

FIG. 6 is a flowchart illustrating a corrected distance data generation process and a corrected velocity data generation process of a synthesis data augmentation method, according to an embodiment. Operations 610 and 620 of FIG. 6 may be included in operation 520 of FIG. 5. In addition, operations 630 and 640 of FIG. 6 may be included in operation 530 of FIG. 5.

In operation 610, the synthesis distance data generator 220 may generate synthesis distance data R_{synthesis} using the 3D coordinate data 201.

In operation 620, the first Taylor first-order expansion input corrector 260 may perform Taylor first-order expansion input correction on the synthesis distance data R_{synthesis} generated in operation 610 to generate the corrected distance data R_{corrected}.

In operation 630, the synthesis velocity data generator 230 may generate synthesis velocity data v_{synthesis} using the Doppler data 202.

In operation 640, the second Taylor first-order expansion input corrector 270 may perform Taylor first-order expansion input correction on the synthesis velocity data v_{synthesis} generated in operation 630 to generate the corrected velocity data v_{corrected}.

Here, in operation 540, the input data distribution inspector 240 may inspect the data distribution of the synthesis distance data R_{synthesis} generated in operation 610 and the synthesis velocity data v_{synthesis} generated in operation 630 to determine an average value and variance of the distance data and an average value and variance of the velocity data. In addition, the synthesis noise data generator 250 may generate the synthesis distance noise data ϵ_{R}_{_{synthesis}}, which is synthesis noise data with respect to distance, based on an average and variance of the synthesis distance data R_{synthesis}. In addition, the synthesis noise data generator 250 may generate the synthesis velocity noise data ϵᵥ_{_{synthesis}}, which is synthesis noise data with respect to velocity, based on an average and variance of the synthesis velocity data v_{synthesis}.

According to embodiments, noise and distortion of radar data may be minimized, and reliability of a radar system and data accuracy may be improved, by applying Taylor first-order expansion to 3D coordinate data and Doppler data received from a radar to correct distance and velocity data and then synthesizing and augmenting the distance and velocity data.

In addition, according to embodiments, by generating synthesis augmented data similar to an actual environment by reflecting various noise conditions, an issue of insufficient training data may be solved, and diversity and practicality of training data may be improved.

Furthermore, according to embodiments, a frame synchronization and merging block may provide a function of temporally and logically aligning input data and augmented data and merging and storing them in a consistent form, thereby facilitating data set management and ensuring consistency and reliability of data during a training and verification evaluation process of a deep learning model.

In conclusion, the present disclosure may greatly improve accuracy and reliability of radar data processing through physical information-based data correction and augmentation technology and may greatly improve data quality for utilization of deep learning training data. Through this, the present disclosure may provide a practical effect of greatly improving performance and generalization ability of deep learning models in various application fields such as autonomous driving, drones, robots, and object tracking.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic apparatuses, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multitasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to one of ordinary skill in the art that various modifications based on the technical spirit of the present disclosure, as well as the disclosed embodiments, can be made.

What is claimed is:

1. A method of augmenting synthesis data, the method comprising:
generating correction data by performing Taylor first-order expansion correction on input data;
generating synthesis noise data according to a data distribution of the input data; and
outputting synthesis augmented data using the correction data and the synthesis noise data.

2. The method of claim 1, further comprising:
separating the input data into three-dimensional (3D) coordinate data and Doppler data, wherein the correction data comprises corrected distance data and corrected velocity data; and
the generating of the correction data comprises:
generating the corrected distance data by performing Taylor first-order expansion correction on the 3D coordinate data; and
generating the corrected velocity data by performing Taylor first-order expansion correction on the Doppler data.

3. The method of claim 2, wherein
the generating of the corrected distance data comprises:
generating synthesis distance data using the 3D coordinate data; and
generating the corrected distance data by performing Taylor first-order expansion correction on the synthesis distance data.

4. The method of claim 3, wherein
the generating of the synthesis distance data comprises:
calculating a Euclidean distance with respect to the 3D coordinate data;
calculating a weight-based distance with respect to the 3D coordinate data;
calculating a probabilistic distance with respect to the 3D coordinate data; and
outputting, as the synthesis distance data, one of a result of calculating the Euclidean distance, a result of calculating the weight-based distance, and a result of calculating the probabilistic distance.

5. The method of claim 2, wherein
the generating of the corrected velocity data comprises:
generating synthesis velocity data using the Doppler data; and
generating the corrected velocity data by performing Taylor first-order expansion correction on the synthesis velocity data.

6. The method of claim 5, wherein
the generating of the synthesis velocity data comprises:
calculating a basic Doppler velocity of the Doppler data;
calculating a nonlinear Doppler correction velocity of the Doppler data;
when the Doppler data includes multi-channel Doppler signals, calculating a multi-channel average velocity by combining the multi-channel Doppler signals;
calculating a probabilistic estimation velocity of the Doppler data; and
outputting, as the synthesis velocity data, one of a result of calculating the basic Doppler velocity, a result of calculating the nonlinear Doppler correction velocity, a result of calculating the multi-channel average velocity, and a result of calculating the probabilistic estimation velocity.

7. The method of claim 2, wherein
the generating of the synthesis noise data comprises:
generating synthesis distance noise data, which is synthesis noise data with respect to distance, based on an average and variance of synthesis distance data generated using the 3D coordinate data; and
generating synthesis velocity noise data, which is synthesis noise data with respect to velocity, based on an average and variance of synthesis velocity data generated using the Doppler data.

8. The method of claim 2, wherein
the outputting of the synthesis augmented data comprises:
generating augmented velocity data using the corrected distance data and the synthesis noise data;
generating augmented 3D coordinate data by converting the augmented velocity data to 3D coordinates using the 3D coordinate data;
generating augmented velocity data using the corrected velocity data and the synthesis noise data; and
outputting synthesis augmented data including the augmented 3D coordinate data and the augmented velocity data.

9. A synthesis data augmentation apparatus comprising:
a synthesis distance data generator configured to generate synthesis distance data using three-dimensional (3D) coordinate data of input data;
a first Taylor first-order expansion input corrector configured to generate corrected distance data by performing Taylor first-order expansion correction on the synthesis distance data;
a synthesis velocity data generator configured to generate synthesis velocity data using Doppler data of the input data;
a second Taylor first-order expansion input corrector configured to generate corrected velocity data by performing Taylor first-order expansion correction on the synthesis velocity data;
a synthesis noise data generator configured to generate synthesis noise data according to data distribution of the synthesis distance data and the synthesis velocity data; and
a third data merger configured to output synthesis augmented data generated using the corrected distance data, the corrected velocity data, and the synthesis noise data.

10. The synthesis data augmentation apparatus of claim 9, further comprising:
a data divider configured to separate the input data into 3D coordinate data and Doppler data.

11. The synthesis data augmentation apparatus of claim 9, wherein
the synthesis distance data generator comprises:
a Euclidean distance calculator configured to calculate a Euclidean distance with respect to the 3D coordinate data;
a weight-based distance calculator configured to calculate a weight-based distance with respect to the 3D coordinate data;
a probabilistic distance calculator configured to calculate a probabilistic distance with respect to the 3D coordinate data; and
a selector configured to output, as the synthesis distance data, one of a result of calculating the Euclidean distance, a result of calculating the weight-based distance, and a result of calculating the probabilistic distance.

12. The synthesis data augmentation apparatus of claim 9, wherein
the synthesis velocity data generator comprises:
a basic Doppler-based velocity calculator configured to calculate a basic Doppler velocity of the Doppler data;
a nonlinear Doppler calculator configured to calculate a nonlinear Doppler correction velocity of the Doppler data;
a multi-channel Doppler combiner configured to calculate a multi-channel average velocity by combining the multi-channel Doppler signals when the Doppler data includes multi-channel Doppler signals;
a probabilistic velocity estimator configured to calculate a probabilistic estimation velocity of the Doppler data; and
a selector configured to output, as the synthesis velocity data, one of a result of calculating the basic Doppler velocity, a result of calculating the nonlinear Doppler correction velocity, a result of calculating the multi-channel average velocity, and a result of calculating the probabilistic estimation velocity.

13. The synthesis data augmentation apparatus of claim 9, wherein
the synthesis noise data generator is configured to:
generate synthesis distance noise data, which is synthesis noise data with respect to distance, based on an average and variance of synthesis distance data generated using the 3D coordinate data; and
generate synthesis velocity noise data, which is synthesis noise data with respect to velocity, based on an average and variance of synthesis velocity data generated using the Doppler data.

14. The synthesis data augmentation apparatus of claim 9, further comprising:
a first data merger configured to generate augmented velocity data using the corrected distance data and the synthesis noise data;
an augmented 3D coordinate converter configured to generate augmented 3D coordinate data by converting the augmented velocity data to 3D coordinates using the 3D coordinate data; and
a second data merger configured to generate augmented velocity data using the corrected velocity data and the synthesis noise data,
wherein the third data merger is configured to output synthesis augmented data including the augmented 3D coordinate data and the augmented velocity data.
